(19) United States
(12) Patent Application Publication
(10) Pub. No.: US 2006/0172202 A1
(43) Pub. Date: Aug. 3, 2006

(54) Low temperature electrolytes and cell construction for low temperature lithium rechargeable batteries

(76) Inventors: W. Novis Smith, Philadelphia, PA (US); Joseph B. Kejha, Meadowbrook, PA (US); Jim Gormley, Ardsley, PA (US); Joel R. McCloskey, Philadelphia, PA (US)

Correspondence Address: ZACHARY T. WOBENSMITH, III, 6091 Carversville/Wismer Road, P.O. Box 370, Pipersville, PA, 18947-0370, US

(21) Appl. No.: 11/049,093

(22) Filed: Feb. 3, 2005

(51) Int. Cl. H01M 10/40

(52) U.S. Cl. 429/332

(57) ABSTRACT

Low temperature electrolytes for use in lithium batteries which provide improved low temperature performance, and include combinations of methyl acetate, ethylene carbonate, ethyl acetate, ethylmethyl carbonate and a lithium salt.

### CROSS REFERENCE TO RELATED DOCUMENTS

The subject matter of the invention is shown and described in the disclosure document of W. Novis Smith, Joseph B. Kejha, Jim Gormley and Joel McCloskey Ser. No. 546,573 filed Feb. 9, 2004, and entitled “Low Temperature Electrolytes and Cell Construction For Low Temperature Lithium Rechargeable Batteries”.

### BACKGROUND OF THE INVENTION

1. Field of the Invention

This invention relates to low temperature lithium rechargeable batteries which have improved low temperature discharge performance.

2. Description of the Prior Art

There is a recognized need at the National Aeronautics and Space Administration (NASA) and the Department of Defense (DOD) for lithium-ion batteries that provide good low temperature discharge performance at −40° or lower. These batteries are used in Air Force application such as combat aircraft, in NASA Satellites, Mars Landers and Probes, and Moon missions.

Available prior art electrolytes which can operate at low temperatures (−40° or lower) achieve about 60-66% of room temperature capacity at a c/10 discharge rate. See report entitled “Improved Low Temperature Performance of Lithium-ion Cells With Low Ethylene Carbonate (EC) Content Electrolytes” by M. C. Smart, B. U. Ratnakumar and S. Suram Pudi of Jet Propulsion Laboratory, and by H. Croft, D. Tice and R. Staniewicz of Saft America, Inc. These Lithium-ion cells utilized electrolyte composed of 1MPF₆/EC/DEC/DMC/EMC (1:1:1:3) where (M=mole, LiPF₆=Lithium-Hexafluorophosphate, EC=Ethylene Carbonate, DEC=Diethyl Carbonate, DMC=Dimethyl Carbonate, and EMC=Ethylmethyl Carbonate), however, the cells only achieved about 60-66% of room temperature performance at low temperatures.

Electrolytes which contain methyl acetate (MA) in combination with ethylene carbonate (EC), ethyl acetate (EA), ethylmethyl carbonate (EMC), and a LiPF₆ salt; and electrolytes which contain EC and EMC only, with LiPF₆ salt provide dramatically improved low temperature capacity at c/10 discharge.

### SUMMARY OF THE INVENTION

It has now been found that a rechargeable low temperature lithium battery with up to 90% of room temperature performance, can be obtained by using an electrolyte, which contains methyl acetate (MA) in combination with ethylene carbonate (EC), ethyl acetate (EA), ethylmethyl carbonate (EMC) and LiPF₆ salt, and by using an electrolyte which contains a low percent EC, and EMC/only, with LiPF₆ salt.

The principal object of the invention is to provide a low temperature rechargeable lithium battery that at −40°C., achieves up to 90% of the discharge capacity of these batteries at room temperature.

A further object of the invention is to provide a battery of the character aforesaid which is simple and inexpensive to construct

A further object of the invention is to provide a battery of the character aforesaid which is durable and long lasting in service.

A further object of the invention is to provide a battery of the character aforesaid which is particularly suitable for mass production.

Other objects and advantageous features of the invention will be apparent from the description and claims.

### DESCRIPTION OF THE DRAWINGS

The nature and characteristic features of the invention will be more readily understood from the following description taken in connection with the accompanying drawings forming part hereof in which:

FIG. 1 is a top plan view of a low temperature rechargeable lithium cell constructed in accordance with the invention, and

FIG. 2 is a vertical sectional view taken approximately on the line 2-2 of FIG. 1.

It should, of course, be understood that the description and drawings herein are merely illustrative, and that various modifications and changes can be made in the structures disclosed without departing from the spirit of the invention.

### DESCRIPTION OF THE PREFERRED EMBODIMENTS

When referring to the preferred embodiments, certain terminology will be utilized for the sake of clarity. Use of such terminology is intended to encompass not only the described embodiment, but also technical equivalents which operate and function in substantially the same way to bring about the same result.

Referring now to the electrolyte composition for low temperature rechargeable lithium batteries, one embodiment of the electrolyte is a combination of methyl acetate (MA) with ethylene carbonate (EC), ethyl acetate (EA), and ethylmethyl carbonate (EMC) and LiPF₆ salt. The composition of 1 Molar LiPF₆ in EC/MA/EA/EMC (1:1:1:3 weight ratio) is the preferred composition.

Another composition which has been found to achieve 90% of the room temperature discharge performance is 1 Molar LiPF₆ in EC/EA/EMC in a (1:2:3 weight ratio.)

Another composition which achieved a very good discharge performance at −40° C., which is equivalent to the prior art compositions as described in the M. C. Smart et al. publication, is a composition of 1 Molar LiBOB (Lithium bis-oxalatoborate) in combination with EC and MA, or EA such as 1 Molar LiBOB in EC/MA in a (30:70 weight ratio), or 1 Molar LiBOB in EC/EA (30:70 weight ratio) or their mixtures.

A composition of 1 Molar LiBOB in EC/EA/EMC (1:2:3 weight ratio) also provides very good low temperature discharge performance.

It has been found that the LiBOB dissolves into the MA, if the EC is at least 25% of the blend and also dissolves into the EA, if the EC is at least 15% of the blend.

An electrolyte composition which has been found to provide excellent discharge and recharge characteristics at temperatures of −40° C. to −50° C. is 1 Molar LiPF₆ in EC/EMC (16:84 weight ratio.) The electrolyte composition at these low temperatures achieved a 90% discharge capacity of the room temperature capacity, and about 50% of the room temperature capacity on charging at low temperature. The optimum lithium cell useful with the described electrolytes is a prismatic cell, with an ultra thin (0.5 mil) microporous separator, which is welded to thinner electrodes (50% of the normal thickness) with full width current collector terminal tabs, and with a lower discharge voltage of 2 volts in comparison to the normal discharge voltage of 3.0 volts. The charge voltage is 4.2 volts. The cell design is similar to the high rate cell design, since the kinetics are similar.

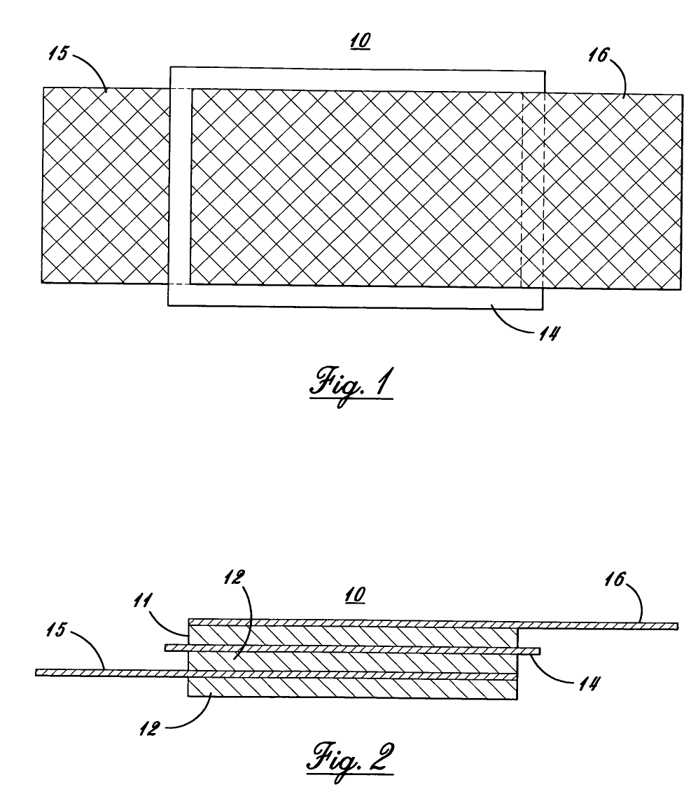

Referring to FIGS. 1 and 2, a preferred form of lithium cell 10 is illustrated, which includes a cathode 12 of any lithiated cathode material, preferably of LiCoO₂, and an anode 11 preferably of (mesocarbon microbeads) MCMB, but can be of a metal, or a lithium insertion capable compound. An ultra thin microporous separator 14 is provided which is welded to the cathode 12 and/or glued to the anode 11. The cathode 12 is provided with a metal current collector grid 15, and the anode 11 is provided with a collector grid 16. The electrolyte (not shown) is contained in the separator 14, and in the electrodes 11 and 12. The electrolytes can be of any of the described compositions, with 1 Molar LiPF₆ in EC/MA/EA/EMC (1:1:1:3 weight ratio) and 1 Molar LiPF₆ in EC/EMC (16:84 weight ratio) being the preferred compositions.

The cell 10 after construction is charged at room temperature at C/5 rate to 4.2Volts. The conductivity of the described electrolytes is higher than conventional electrolytes, such as 1 Molar LiPF₆ in EC/DMC (1:1 weight ratio), at any temperature up to 40° C., due to their low viscosity and the ratio of selected solvents and salts.

It should be noted that unless otherwise specified the ranges of materials used should be within ±15% of the suggested percentages and moles. It will thus be seen that low temperature rechargeable lithium batteries have been described with which the objects of the invention are achieved.

We claim:

1. A low temperature, electrolyte composition for low temperature operation of lithium batteries which composition comprises:
ethylene carbonate (EC) less than 30% by weight
methyl acetate (MA), and/or
ethyl acetate (EA),
ethylmethyl carbonate (EMC), and
Li-PF₆ salt.

2. A low temperature electrolyte composition as defined in claim 1 in which the composition comprises
1 Molar LiPF₆ in EC/MA/EA/EMC (1:1:1:3 weight ratio).

3. A low temperature electrolyte composition for low temperature operation of lithium batteries which composition comprises
ethylene carbonate (EC) less than 30% by weight,
ethyl acetate (EA),
ethylmethyl carbonate (EMC), and
LiPF₆ salt.

4. A low temperature electrolyte composition as defined in claim 3 in which the composition comprises.
1 Molar LiPF₆ in EC/EA/EMC (1:2:3 weight ratio).

5. A low temperature electrolyte composition for low temperature operation of lithium batteries which composition comprises:
ethylene carbonate (EC) less than 30% by weight,
methyl acetate (MA), and/or
ethyl acetate (EA), and
lithium bis-oxalatoborate (LiBOB) salt.

6. A low temperature electrolyte composition for low temperature operation of lithium batteries, as defined in claim 5 which composition comprises:
ethylene carbonate (EC), and
methyl acetate (MA) in a weight ratio of 30:70 with 1 Molar LiBOB salt concentration, wherein said ratios and molar concentrations are ±15%.

7. A low temperature electrolyte composition for low temperature operation of lithium batteries as defined in claim 5 which composition comprises:
ethylene carbonate (EC) and
ethyl acetate (EA) in a weight ratio of 30:70 with 1 Molar LiBOb salt concentration, wherein said ratios and molar concentrations are ±15%.

8. A low temperature electrolyte composition for low temperature operation of lithium batteries as described in claim 5 which composition comprises:
ethylene carbonate (EC),
ethyl acetate (EA), and
ethylmethyl carbonate (EMC) in a weight ratio of 1:2:3, with 1 Molar LiBOB salt concentration, wherein said ratios and molar concentrations are ±15%.

9. A low temperature electrolyte composition for low temperature operation of lithium batteries which composition comprises:
ethylene carbonate (EC), and
ethylmethyl carbonate (EMC) in a weight ratio of 16:84, with 1 Molar LiPF₆ salt concentration, wherein said ratio and molar concentrations are ±15%.

10. A lithium battery for low temperature operation incorporating the electrolytes of claims 1, or 3, or 5, or 6, or 7, or 8, which comprises:
an anode;
a cathode;
a microporous separator between and welded to
said anode and said cathode,
wherein said electrolyte is contained in said separator and said electrodes, and metal current collectors are provided on said anode and said cathode with full width terminal tabs.
